(19) United States
(12) Patent Application Publication
(10) Pub. No.: US 2014/0088221 A1
(43) Pub. Date: Mar. 27, 2014

(54) THERMOPLASTIC ELASTOMERS MOLDABLE UNDER LOW SHEAR CONDITIONS

(71) Applicant: POLYONE CORPORATION, Avon Lake, OH (US)

(72) Inventors: Gerald Meyer, Crystal Lake, IL (US); William Pepe, Wonder Lake, IL (US)

(73) Assignee: POLYONE CORPORATION, Avon Lake, OH (US)

(21) Appl. No.: 14/119,805

(22) PCT Filed: May 22, 2012
(86) PCT No.: PCT/US2012/038929

§ 371 Date: Nov. 22, 2013

Related U.S. Application Data
(60) Provisional application No. 61/489,814, filed on May 25, 2011.

(51) Int. Cl. C08L 53/00; B29C 41/04

(52) U.S. Cl. CPC C08L 53/00; B29C 41/04
USPC 523/122; 524/562; 524/505; 264/310

(57) ABSTRACT

A thermoplastic elastomer compound of an acrylic-containing styrenic block copolymer and plasticizer oil have been found to be capable of sintering at a temperature ranging from about 180 C to about 200 C when the copolymer and the oil are in no more than a 2:1 weight ratio. The compound can be used in rotomolding or slush-molding equipment to make plastic articles having elastomeric properties.

### CLAIM OF PRIORITY

This application claims priority from U.S. Provisional Patent Application Ser. No. 61/489,814 bearing Attorney Docket Number 12011009 and filed on May 25, 2011, which is incorporated by reference.

### FIELD OF THE INVENTION

This invention relates to thermoplastic elastomers capable of being rotomolded or slush-molded into thermoplastic elastomer articles.

### BACKGROUND OF THE INVENTION

The world of polymers has progressed rapidly to transform material science from wood and metals of the 19^{th} Century to the use of thermoset polymers of the mid-20^{th} Century to the use of thermoplastic polymers of later 20^{th} Century.

Thermoplastic elastomers (TPEs) combine the benefits of elastomeric properties of thermoset polymers, such as vulcanized rubber, with the processing properties of thermoplastic polymers. Therefore, TPEs are preferred because they can be made into articles using injection molding equipment.

Traditionally, parts made via rotomolding or slush-molding processes use homo- or copolymers of ethylene because the resins have high melt flow properties and an ability to be pelletized or ground into very fine powders with high surface area, which allow for increased flow during the rotomolding or slush-molding process. These polyethylene resins typically have particle sizes between about 300 and about 1500 microns to facilitate the flow and sintering process which both rotomolding and slush-molding equipment require. The inherent drawbacks of using polyethylene resins are that they are typically much harder (Hardness on the Shore D scale) and do not produce parts with a soft, tactile feel.

To obtain roto- or slush-molded parts with softer, tactile haptics, one must use polyvinyl chloride (PVC) resins, typically with phthalate plasticizers, to produce parts via rotomolding or slush molding operations; however, manufacturers are now less likely to desire the use of PVC or phthalates in their molded plastic articles.

Attempts have been made in roto- or slush-molding operations to use TPEs made from styrenic block copolymers (SBCs). In such cases, micropellets have been produced (˜1000 micron in diameter) using extruder dies with small orifices. Unfortunately, the resulting rotomolded parts made from such SBC micropellets have exhibited high amounts of bubbles, indicating that during the sintering process of the TPE resin, insufficient molten flow was prevalent. In addition, the TPE exhibited severe yellowing because temperatures in excess of 200° C. were used to obtain sufficient resin flow and sintering.

Alternatively, cryogenic grinding could be used to reduce the size of TPE pellets and increase the surface area. But as is well known, a cryogenic grinding process adds significant cost to the process of making roto- or slush-moldable TPEs.

### SUMMARY OF THE INVENTION

What the art needs is a new formulation of thermoplastic elastomer (TPE) that has the ability to melt and flow under low shear conditions such that pellets or powders of the TPE can be molded into plastic articles using rotomolding or slush-molding equipment.

The present invention solves that problem by using a TPE formulation which utilizes a highly flowable SBC resin.

More specifically, the SBC resin has a melt flow rate of about 5.6 g/10 mins. when measured using at 230° C. and 2.16 kg.

One aspect of the invention is a thermoplastic elastomer compound, comprising a highly flowable acrylic-containing styrenic block copolymer; plasticizer oil; and optionally, functional additives, wherein when the copolymer and the oil are present in no more than a 2:1 weight ratio the compound is capable of sintering at a temperature ranging from about 180° C. to about 200° C.

Another aspect of the invention is a molded article of the above compound, using rotomolding or slush-molding techniques.

Features of the invention will become apparent with reference to the following embodiments.

### EMBODIMENTS OF THE INVENTION

Acrylic-Containing Styrenic Block Copolymer

The present invention benefits from the use of a commercially available SBC from Kuraray, marketed as Septon® Q1250 grade or Septon® KL-Q1250 grade. The exact chemistry of Septon® Q1250 SBC is not presently known but is believed to be described in either or both of U.S. Pat. No. 7,772,319 (Fujihara et al.) and U.S. Pat. No. 7,906,584 (Suzuki et al.), both incorporated by reference herein.

Septon® Q1250 SBC or Septon® KL-Q1250 SBC has been identified as having the following physical properties as seen in Table 1.

TABLE 1
Grade Q1250 Properties

| | |
|---|---|
| Hard content (wt %) | 31 |
| Specific gravity (g/cm³) | 0.93 |
| Hardness (JIS A) | 74 |
| 100% modulus @ 25° C. (MPa) | 3.5 |
| Tensile strength* @ 25° C. (MPa) | 29.5 |
| Elongation @ 25° C. (%) | 500 |
| 100% Modulus @ 80° C. (MPa) | 2.1 |
| Tensile Strength* @ 80° C. (MPa) | 11.4 |
| Elongation @ 80° C. (%) | 600 |
| Melt Flow Rate @ 230° C. and | 5.6 |
| 2.16 kgf (g/10 min) | |
| Solution Viscosity @ 10 wt % in | 15 |
| Toluene at 30° C. (mPa · s) | |

*Tensile Measurements: Crosshead speed 500 mm/min

Plasticizer Oil

A plasticizer oil is useful, preferably at about 100 viscosity. For TPEs of the present invention, the plasticizer can be mineral oil, commercially available from a number of convenient sources. The plasticizer contributes softness and tactile feel along with improved flow properties to the TPE.

Optional SEEPS

The compound can also include styrene-ethylene-ethylene/propylene-styrene (SEEPS) which assists the compound by improving physical properties without loss of the most important flow characteristics. SEEPS can have a weight average molecular weight ranging from about 75,000 to about 400,000 g/mole and preferably from about 100,000 to about 300,000 g/mole.

Optional Polyolefin

The compound can also include polyolefin, preferably polypropylene, to also adjust physical properties without loss of flow characteristics. The polyolefin can have a melt flow rate at 230° C. ranging from about 30 to about 1000 and preferably from about 400 to about 1000.

Optional Additives

The compound of the present invention can include conventional plastics additives in an amount that is sufficient to obtain a desired processing or performance property for the compound. The amount should not be wasteful of the additive nor detrimental to the processing or performance of the compound. Those skilled in the art of thermoplastics compounding, without undue experimentation but with reference to such treatises as Plastics Additives Database (2004) from Plastics Design Library (www.williamandrew.com), can select from many different types of additives for inclusion into the compounds of the present invention.

Non-limiting examples of optional additives include adhesion promoters; biocides (antibacterials, fungicides, and mildewcides), anti-fogging agents; antioxidants; anti-static agents; bonding, blowing and foaming agents; dispersants; fillers and extenders; fire and flame retardants and smoke suppressants; impact modifiers; initiators; lubricants; micas; pigments, colorants and dyes; oils and plasticizers; processing aids; release agents; silanes, titanates and zirconates; slip and anti-blocking agents; stabilizers; stearates; ultraviolet light absorbers; viscosity regulators; waxes; and combinations of them. Of these optional additives, waxes and antioxidants are often used.

Table 1 shows the acceptable and desirable ranges of ingredients for the compound of the present invention. The compound can comprise these ingredients, consist essentially of these ingredients, or consist of these ingredients.

TABLE 2
Ranges of Ingredients

| Ingredient | | | |
|---|---|---|---|
| (Wt. Percent) | Acceptable | Desirable | Preferred |
| Acrylic-containing SBC | 25-75% | 30-70% | 35-70% |
| Plasticizer | 75-25% | 60-40% | 50-30% |
| Optional SEEPS | 0-25% | 0-15% | 10-15% |
| Optional Polyolefin | 0-10% | 1-8% | 2-6% |
| Optional Anti-oxidant | 0-1% | 0-0.5% | 0-0.3% |
| Other Optional Additives | 0-10% | 0-2% | 0-1% |

Processing

The preparation of compounds of the present invention is uncomplicated. The compound of the present can be made in batch or continuous operations.

Mixing in a continuous process typically occurs in an extruder that is elevated to a temperature that is sufficient to melt the polymer matrix with addition at the head of the extruder. Extruder speeds can range from about 50 to about 500 revolutions per minute (rpm), and preferably from about 300 to about 500 rpm. Typically, the output from the extruder is pelletized for later extrusion or molding into polymeric articles.

Mixing in a batch process typically occurs in a Banbury mixer that is also elevated to a temperature that is sufficient to melt the polymer matrix to permit addition of the solid ingredient additives. The mixing speeds range from 60 to 1000 rpm. Also, the output from the mixer is chopped into smaller sizes for later extrusion or molding into polymeric articles.

Subsequent extrusion or molding techniques are well known to those skilled in the art of thermoplastics polymer engineering. Without undue experimentation but with such references as “Extrusion, The Definitive Processing Guide and Handbook”; “Handbook of Molded Part Shrinkage and Warpage”; “Specialized Molding Techniques”; “Rotational Molding Technology”; and “Handbook of Mold, Tool and Die Repair Welding”, all published by Plastics Design Library (www.williamandrew.com), one can make articles of any conceivable shape and appearance using compounds of the present invention.

Preferably, rotomolding or slush molding can be used to form useful articles from the TPEs of the present invention. Rotomolding utilizes a closed-end mold design for forming articles. Slush molding utilizes an open-end mold design for forming articles (e.g., vehicle instrument panels) as a polymeric skin. One skilled in the art can understand the principles of rotomolding and slush-molding by referring to U.S. Pat. No. 6,797,222 (Hausmann et al.) and U.S. Pat. No. 2,736,925; U.S. Pat. No. 3,039,146; European Patent Publication 0 339 222, European Patent Publication 0 476 742 and PCT Patent Publication WO 0207946.

Briefly, rotomolding or rotational molding generally involves the following steps: a) a mold is loaded with a measured charge or shot weight of polymeric material (usually in powder form) into the mold; b) The mold is heated in an oven while it rotates, until all the polymer has melted and adhered to the mold wall. The hollow part should be rotated through two or more axes, rotating at different speeds, in order to avoid the accumulation of polymer powder. The length of time the mold spends in the oven is critical: too long and the polymer will degrade, reducing its impact strength. If the mold spends too little time in the oven, the polymer melt may be incomplete. The polymer pellets or powder will not have time to fully melt and coalesce on the mold wall, resulting in large bubbles in the polymer. This has an adverse effect on the mechanical properties of the finished product; c) After correct time, rotations, and temperature, the mold is cooled, usually by a fan. The polymer must be cooled so that it solidifies and can be handled safely by the mold operator. This typically takes tens of minutes. The part will shrink on cooling, coming away from the mold, and facilitating easy removal of the part; and d) The part is then removed from the mold.

Briefly, slush-molding generally involves the following steps: a) an open-air tank is first filled with a suitable polymer powder in a sufficient quantity and with grain sizes typically below 500 micrometers; b) a mold, usually electroplated with nickel, is then heated to a given temperature; c) the tank and the mold are then coupled in a closed system with suitable coupling means; d) the system is moved so that the tank transfers the powder onto the mold, thus obtaining a uniform layer of partially or completely melted powder which adheres to the mold; e) the closed system is then opened after being brought to the initial conditions again; at this stage the possible excess polymer powder deposits again into the tank and can thus be regenerated; f) the mold can now be heated in order to complete the melting; g) the mold is then cooled with suitable cooling means; and h) the formed sheet is stripped off as a semi-finished product which can then be assembled with a support in order to obtain the finished product in the form of instrument panels, door panels, etc. for the upholstery of cars.

The TPEs of the present invention are particularly suitable for use with rotomolding or slush molding processing techniques because the pellets can flow with very little or no shear force applied, making it possible to sinter in a rotomolding mold or a slush-molding mold, previously equipment not used with TPEs. As a result, TPEs have now become suitable for plastic articles normally made by these specialized molding techniques.

### USEFULNESS OF THE INVENTION

TPEs of the present invention are capable of being rotomolded or slush-molded. Plastic articles can be made from formulations of the present invention for such uses as elastomeric skins, parts for dolls or other toys, water and food storage and shipping containers and tanks, also as impact modifiers for polyolefin rotomolded articles such as trash cans. Unlike other plastic articles which are thermoplastic, but not elastic, TPEs provide the versatility of thermoplastic processing with the versatility of elastomeric performance.

### EXAMPLES

Table 3 shows the ingredients for Comparative Examples A-F and Examples 1-10. Tables 4-6 show the recipes and results of experimentation for Comparative Examples A-C, Examples 1-7, and Comparative Examples D-F and Examples 8-10, respectively.

In the Examples and Comparative Examples, a co-rotating twin screw extruder was used to mix and compound the TPE formulations. The were then underwater pelletized using a Gala Underwater pelletizer system.

Die hole sizes were typically 2.4 to 2.8 mm in size with the resulting pellets averaging from 30 to 80 pellets per gram. The pellets were dusted with a partitioning agent such as talc, polyolefin wax, metal stearate, silica or other mineral fillers to keep them free from blocking during storage before use.

All of Examples 1-10 and Comparative Examples A-F were made using a twin-screw extruder set at 149-193° C. in #1-3 zones; 171-204° C. in #4-7 zones; 160-204° C. in #8-10 zones, rotating at 250-400 rpm. All ingredients were added before Zone 1. The melt-mixed compound was pelletized for further handling.

Pellets of all Examples and Comparative Examples were molded into tensile test bars using a Ferromatik Milacron injection molding machine, operating at 177° C. temperature at the nozzle and 149° C. temperature at the feed throat and high pressure.

TABLE 3
Source of Ingredients

| Ingredient | | | Commercial |
|---|---|---|---|
| Name | Purpose | Generic Name | Source |
| Kraton G-1652 | Elastomer | SEBS | Kraton Polymers |
| | | | (Houston) |
| Kraton G-1650 | Elastomer | SEBS | Kraton Polymers |
| Septon 4033 | Elastomer | Styrene Ethylene | Kuraray America |
| | | Ethylene | Inc. (Houston) |
| | | Propylene Styrene | |
| | | Copolymer | |
| | | (SEEPS) | |
| Septon KL- | Elastomer | Acrylic-containing | Kuraray America |
| Q1250 | | SBC | Inc. |
| Puretol 10 | Plasticizer | White Mineral Oil/ | Petro-Canada |
| | | Paraffinic Oil | (Toronto) |
| MF650W | Property | Metocene | LyondellBasell |
| | Adjuster | Polypropylene | |
| | | (melt flow = 500) | |

TABLE 3
Source of Ingredients

| Ingredient | | | Commercial |
|---|---|---|---|
| Name | Purpose | Generic Name | Source |
| Irganox 1010 | Antioxidant | Tetrakis[methylene | Chidley & Peto |
| | | (3,5-di-tert-butyl- | (Distributor) |
| | | 4-hydroxy-hydro- | (Carol Stream, IL) |
| | | cinnamate)] | |
| | | methane | |
| Irgafos 168 | Antioxidant | Tris (2,4-di(tert)- | Chidley & Peto |
| | | butylphenyl) | (Distributor) |
| | | phosphite | |
| Kemamide E | Wax | Euracamide wax | PolyOne |
| Ultra | | | (Distributor) |
| | | | (Avon Lake, OH) |

TABLE 4

| Example | | |
|---|---|---|
| A | B | C |

| | | | |
|---|---|---|---|
| Kraton G-1650 | 49.78 | 24.89 | 12.44 |
| Septon KL-Q1250 | | 24.89 | 37.33 |
| Puretol 10 | 49.77 | 49.77 | 49.78 |
| Kemamide E Ultra | 0.15 | 0.15 | 0.15 |
| Irganox 1010 | 0.15 | 0.15 | 0.15 |
| Irgafos 168 | 0.15 | 0.15 | 0.15 |
| Total | 100.00 | 100.00 | 100 |
| Shore A Hardness | 26 | 24 | 22 |
| (ASTM D2240, 10 sec) | | | |
| Tensile Strength (psi) | 379 | 383 | 343 |
| Elongation (%) | 705 | 642 | 605 |
| Capillary Viscosity @ | 67 | Too low to | Too low to |
| 67/sec (Measured at | | measure | measure |
| 200° C.) | | | |
| Capillary Viscosity @ | 825 | Not | 340 |
| 67/sec (Measured at | | Measured | |
| 130° C.) | | | |

TABLE 5

| | Example | | | | | |
|---|---|---|---|---|---|---|
| | 1 | 2 | 3 | 4 | 5 | 6 |
| Septon 4033 | | | | | | |
| Septon KL-Q1250 | 50 | 57.14 | 66.67 | 40 | 35 | 30 |
| Puretol 10 | 50 | 42.86 | 33.33 | 60 | 65 | 70 |
| Kemamide E Ultra | | | | | | |
| Irganox 1010 | | | | | | |
| Irgafos 168 | | | | | | |
| Total | 100 | 100 | 100 | 100 | 100 | 100 |
| Shore A Hardness (ASTM | 24 | 30 | 42 | 14 | 14 | 9 |
| D2240, 10 sec) | | | | | | |
| Tensile Strength (psi) | 472 | 740 | 1023 | 170 | 212 | 185 |
| Elongation (%) | 662 | 684 | 701 | 542 | 601 | 390 |
| Capillary Viscosity @ 67/sec | Too low to | 54 | 68 | Too low to | Too low to | Too low to |
| (Measured at 200° C.) | measure | | | measure | measure | measure |
| Capillary Viscosity @ 67/sec | | 300 | 851 | | | |
| (Measured at 150° C.) | | | | | | |
| Brookfield Viscosity (350° F., #27 | 28,000 | | | 4,100 | 6,000 | 1,500 |
| Spindle) | | | | | | |
| Brookfield Viscosity (375° F., #27 | | 48,000 | | | | |
| Spindle) | | | | | | |
| Sintered into continuous shell in | Continuous | Continuous | Continuous | Continuous | Continuous | Continuous |
| Brookfield tube | shell | shell | shell | shell | shell | shell |

TABLE 6

| | Example | | | | | | |
|---|---|---|---|---|---|---|---|
| | D | E | F | 7 | 8 | 9 | 10 |
| Kraton G-1652H | 50 | 57.14 | 66.67 | | | | |
| Septon 4033 | | | | | | | 12.44 |
| Septon KL-Q1250 | | | | 48.92 | 47.89 | 46.86 | 37.33 |
| Puretol 10 | 50 | 42.86 | 33.33 | 48.92 | 47.89 | 46.86 | 49.78 |
| MF650W | | | | 1.96 | 4.02 | 6.1 | |
| Kemamide E Ultra | | | | | | | 0.15 |
| Irganox 1010 | | | | 0.1 | 0.1 | 0.09 | 0.15 |
| Irgafos 168 | | | | 0.1 | 0.1 | 0.09 | 0.15 |
| Total | 100 | 100 | 100 | 100 | 100 | 100 | 100 |
| Shore A Hardness | 25 | 34 | 51 | 29 | 34 | 33 | 26 |
| (ASTM D2240, 10 sec) | | | | | | | |
| Tensile Strength (psi) | 157 | 302 | 476 | 473 | 456 | 427 | 453 |
| Elongation (%) | 417 | 479 | 476 | 600 | 583 | 601 | 626 |
| Capillary Viscosity @ | Too low to | Too low to | Too low to | Too low to | Too low to | Too low to | Too low to |
| 67/sec (Measured at | measure | measure | measure | measure | measure | measure | measure |
| 200° C.) | | | | | | | |
| Capillary Viscosity @ | 99 | 278 | 812 | 148 | 109 | 89 | |
| 67/sec (Measured at | | | | | | | |
| 150° C.) | | | | | | | |
| Brookfield Viscosity | 46,500 | | | 43,400 | 49,000 | 41,300 | 30,400 |
| (350° F., #27 Spindle) | | | | | | | |
| Brookfield Viscosity | | 91,400 | | | | | |
| (375° F., #27 Spindle) | | | | | | | |
| Sintered into | Low | Low | No | Continuous | Continuous | Continuous | Continuous |
| continuous shell in | Sintering/ | Sintering/ | Sintering | shell | shell | shell | shell |
| Brookfield tube | Non | Non | | | | | |
| | Continuous | Continuous | | | | | |
| | shell | shell | | | | | |

In Table 4, increasing levels of Q1250 SBC polymer exhibited increased flow and could not be measured by conventional capillary rheometry at 200° C., compared to the control (Comparative Example A) using Kraton G1650, a low molecular weight SEBS polymer. However, when measured at 130° C., higher amounts of Q1250 SBC polymer resulted in a significant reduction of viscosity. Other physical properties were similar to the Kraton G1650 control, shown in Comparative Examples B and C.

In Table 5, a series of formulations (Examples 1-6) with varying amounts of mineral oil were produced to prepare a range of samples with varying hardness values and viscosity values. Hardness values ranged from ˜9 to 42 Shore A. Viscosity values were very low and mostly could not be measured using capillary viscosity measurements at 200° C. The temperature was reduced for the capillary rheometer to 150° C. to begin to measure melt viscosity. In addition, surprisingly, Brookfield viscosity was capable of measuring melt viscosity, which is commonly used for hot melt adhesives and highly plasticized TPEs.

Capillary viscosity measured at 67/sec simulates injection molding conditions, as there is low shear applied to the sample. Brookfield viscosity better simulates rotomolding conditions, because essentially no shear is applied and polymer particles must fuse and sinter with no external shear forces. Simple heating in the Brookfield viscosity tube from 182° C. to 204 ° C. with essentially no shear, resulted in homogeneous melt states of the TPE formulations and when cooled, a continuous, fully sintered shell can be produced, simulating conditions used in rotomolding. Examples 1-6 produced continuous shells, providing a credible prediction of rotomolding success for Examples 1-6.

In Table 6, Comparative Examples D-F match Examples 1-3, except that the Q1250 SBC polymer was replaced by Kraton G1652H, a very low molecular weight SEBS rubber, which is believed to be similar in molecular weight to the Q1250 SBC polymer used in Examples 1-3. The Kraton G1652H-based formulations resulted in TPE samples with similar hardness values as the Q1250 formulations, (D, E, and F vs. 1, 2, and 3, respectively) but exhibited inferior physical properties such as lower tensile strength and elongation. Capillary viscosity values were comparable to the Q1250 Examples 1-3, but when measured by Brookfield viscosity, the Kraton G1652H-based Comparative Examples D-F exhibited very low flow under the same conditions as measured for the Q1250 Examples 1-3. As a result, each of Comparative Examples D-F had a partially sintered shell produced when the pellets were heated in the Brookfield tube, which demonstrated that the use of Septon® Q1250 acrylic-containing SBC was superior for rotomolding over the use of the Kraton G1652H SEBS.

Examples 7-9 explored the use of optional polyolefin as an addition to the blend of equal amounts of Septon® Q1250 acrylic-containing SBC and plasticizer oil, along with small amounts of optional anti-oxidant. As stated previously, polyolefin, such as polypropylene, can assist the compound by increasing modulus and tear strength and can influence hardness and increase adhesion when overmolded onto polyolefins such as polypropylene. The Brookfield Viscosity at 350° F. for Examples 7-9 was much higher than the Brookfield Viscosity at 350° F. for Examples 4-6, but continuous shells were formed nonetheless using the same method of testing as for Examples 1-6.

By review of the varying ingredients and amounts of Examples 1-9, a person having ordinary skill in the art without undue experimentation can generate formulations which will have a variety of end-use physical properties while also capable of being shaped into that final plastic article using rotomolding or slush molding processing techniques.

In Table 6, Example 10, a similar formulation to Comparative Example C, replacing Kraton G1650 with Septon 4033 SEEPS polymer, was made and tested to confirm the low viscosity properties noted in Comparative Example C. Properties were very similar. Surprisingly however, Example 1 produced a continuous shell in the same manner as Examples 1-9. This result showed that Septon 4033 could be blended with Septon® Q1250 SBC without loss of superior flow properties provided by Septon® Q1250 SBC.

In another assessment of the ability of the pellets to flow and sinter in rotational molding or slush molding operations, pellets from Example 3 and Comparative Example F, both with a 2:1 ratio of polymer to 100 viscosity mineral oil, were placed on small petri dishes and placed in a forced air oven. The pellets were heated in stages from 150° C. to 180° C., holding at each temperature for 1 hour. At 160° C., Example 3 exhibited flow and sintering, whereas Comparative Example F, still showed distinct pellets. Even at 180° C., the Comparative Example F pellets exhibited virtually no flow or sintering.

The above Examples and Comparative Examples demonstrate the current invention: formulations and processes to manufacture a thermoplastic elastomer (TPE) in pellet form that can be directly formed into usable objects, via rotomolding, slush molding, or similar low shear processes, without additional reduction in pellet size or surface area.

It was discovered that the use of a specific modified SBC, Septon® KL-Q1250 grade produced by Kuraray, modified with oil and additives, and optionally polyolefin and/or SEEPS, can produce thermoplastic elastomer compounds having a Shore A Hardness from 5 Shore A to about 45 Shore A in hardness which also exhibited very high flow under no or low shear at elevated temperatures. These pellets can be fused or sintered under nearly zero shear conditions. Pellets produced via typical twin screw compounding using underwater pelletizing equipment with pellet sizes ranging typically from 2 to 3 mm, can be used directly in rotomolding or slush-molding without grinding or special equipment to increase the pellet surface area.

The invention is not limited to the above embodiments. The claims follow.

What is claimed is:

1. A thermoplastic elastomer compound, comprising:
(a) highly flowable acrylic-containing styrenic block copolymer;
(b) plasticizer oil; and optionally
(c) functional additives
wherein when the copolymer and the oil are present in no more than a 2:1 weight ratio the compound is capable of sintering at a temperature ranging from about 180° C. to about 200° C.

2. The compound of claim 1, further comprising polyolefin.

3. The compound of claim 1, wherein the acrylic-containing styrenic block copolymer has the following physical properties:

| | |
|---|---|
| Hard content (wt %) | 31 |
| Specific gravity (g/cm³) | 0.93 |
| Hardness (JIS A) | 74 |
| 100% modulus @ 25° C. (MPa) | 3.5 |
| Tensile strength* @ 25° C. (MPa) | 29.5 |
| Elongation @ 25° C. (%) | 500 |
| 100% Modulus @ 80° C. (MPa) | 2.1 |
| Tensile Strength* @ 80° C. (MPa) | 11.4 |
| Elongation @ 80° C. (%) | 600 |
| Melt Flow Rate @ 230° C. and | 5.6 |
| 2.16 kgf (g/10 min) | |
| Solution Viscosity @ 10 wt % in | 15 |
| Toluene at 30° C. (mPa · s) | |

4. The compound of claim 1, further comprising additives selected from the group consisting of adhesion promoters; biocides (antibacterials, fungicides, and mildewcides), anti-fogging agents; anti-static agents; bonding, blowing and foaming agents; dispersants; fillers and extenders; fire and flame retardants and smoke suppresants; impact modifiers; initiators; lubricants; micas; pigments, colorants and dyes; oils and plasticizers; processing aids; release agents; silanes, titanates and zirconates; slip and anti-blocking agents; stabilizers; stearates; ultraviolet light absorbers; viscosity regulators; waxes; and combinations of them.

5. The compound of claim 1, wherein the compound further comprises styrene-ethylene-ethylene/propylene-styrene.

6. The compound of claim 1, wherein the compound is capable of sintering at a temperature ranging from about 180° C. to about 200° C. when in the form of pellets about 2-3 mm in size.

7. A molded article, comprising a compound of claim 1, wherein the article is preparable by rotomolding or slush-molding.

8. A method of using the compound of claim 1, wherein the method comprises the step of rotomolding or slush-molding the compound into an article at sintering temperatures ranging from about 180° C. to about 200° C.
